(19) United States
(12) Patent Application Publication
(10) Pub. No.: US 2025/0056467 A1
(43) Pub. Date: Feb. 13, 2025

(54) METHODS FOR MITIGATING TRANSPARENT TIMING DELAYS IN POSITIONING WITH HAPS AND NTN

(71) Applicant: Nokia Technologies Oy, Espoo (FI)

(72) Inventors: Ryan KEATING, Naperville, IL (US); Tzu-Chung HSIEH, Naperville, IL (US); Frank FREDERIKSEN, Aalborg (DK)

(21) Appl. No.: 18/685,403

(22) PCT Filed: Aug. 31, 2022
(86) PCT No.: PCT/EP2022/074186

§ 371 Date: Feb. 21, 2024

Related U.S. Application Data
(60) Provisional application No. 63/242,870, filed on Sep. 10, 2021.

(51) Int. Cl. H04W 64/00; G01S 5/02; H04B 7/185; H04W 84/06

(52) U.S. Cl. CPC H04W 64/00; G01S 5/021; G01S 5/0236; H04B 7/18519; H04B 7/18563; H04W 84/06

(57) ABSTRACT

Systems, methods, apparatuses, and computer program products for mitigating timing delays in positioning with HAPSs and NTNs. One method may include an LMF receiving a look-up table (303) from a NTN, performing an online re-calibration (309), calculating a transparent processing delay (311), and/or transmitting signal assistance data to a UE as part of new assistance data based upon the received look-up table.

### CROSS-REFERENCE TO RELATED APPLICATION

This application claims priority from U.S. provisional patent application No. 63/242,870 filed on Sep. 10, 2021, the contents of which is hereby incorporated by reference in its entirety.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for mitigating timing delays in positioning with high altitude platform systems (HAPSs) and/or non-terrestrial networks (NTNs).

### BACKGROUND

Examples of mobile or wireless telecommunication systems may include 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine type communication (mMTC). NR is expected to deliver extreme broadband, ultra-robust, low latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some example embodiments, a method may include determining, by a location management entity, that a user equipment is configured to perform positioning using a transparent non-terrestrial network node. The method may further include calculating, by the location management entity, a transparent processing delay using a look-up table. The method may further include transmitting, by the location management entity, signal assistance data comprising the transparent processing delay.

In accordance with certain example embodiments, an apparatus may include means for determining that a user equipment is configured to perform positioning using a transparent non-terrestrial network node. The apparatus may further include means for calculating a transparent processing delay using a look-up table. The apparatus may further include means for transmitting signal assistance data comprising the transparent processing delay.

In accordance with various example embodiments, an apparatus may include at least one processor and at least one memory including computer program code. The at least one memory and the computer program code may be configured to, with the at least one processor, cause the apparatus to at least determine that a user equipment is configured to perform positioning using a transparent non-terrestrial network node. The at least one memory and the computer program code may be further configured to, with the at least one processor, cause the apparatus to at least calculate a transparent processing delay using a look-up table. The at least one memory and the computer program code may be further configured to, with the at least one processor, cause the apparatus to at least transmit signal assistance data comprising the transparent processing delay.

In accordance with some example embodiments, a non-transitory computer readable medium may be encoded with instructions that may, when executed in hardware, perform a method. The method may include determining that a user equipment is configured to perform positioning using a transparent non-terrestrial network node. The method may further include calculating a transparent processing delay using a look-up table. The method may further include transmitting signal assistance data comprising the transparent processing delay.

In accordance with certain example embodiments, a computer program product may perform a method. The method may include determining that a user equipment is configured to perform positioning using a transparent non-terrestrial network node. The method may further include calculating a transparent processing delay using a look-up table. The method may further include transmitting signal assistance data comprising the transparent processing delay.

In accordance with various example embodiments, an apparatus may include circuitry configured to determine that a user equipment is configured to perform positioning using a transparent non-terrestrial network node. The circuitry may further be configured to calculate a transparent processing delay using a look-up table. The circuitry may further be configured to transmit signal assistance data comprising the transparent processing delay.

In accordance with some example embodiments, a method may include generating, by a non-terrestrial network node, a look-up table configured to determine a transparent processing delay. The method may further include transmitting, during a user equipment-based positioning session, by the non-terrestrial network node, signal assistance data to a user equipment as part of assistance data based upon the generated look-up table.

In accordance with certain example embodiments, an apparatus may include means for generating a look-up table configured to determine a transparent processing delay. The apparatus may further include means for transmitting, during a user equipment-based positioning session, signal assistance data to a user equipment as part of assistance data based upon the generated look-up table.

In accordance with various example embodiments, an apparatus may include at least one processor and at least one memory including computer program code. The at least one memory and the computer program code may be configured to, with the at least one processor, cause the apparatus to at least generate a look-up table configured to determine a transparent processing delay. The at least one memory and the computer program code may be further configured to, with the at least one processor, cause the apparatus to at least transmit, during a user equipment-based positioning session, signal assistance data to a user equipment as part of assistance data based upon the generated look-up table.

In accordance with some example embodiments, a non-transitory computer readable medium may be encoded with instructions that may, when executed in hardware, perform a method. The method may include generating a look-up table configured to determine a transparent processing delay. The method may further include transmitting, during a user equipment-based positioning session, signal assistance data to a user equipment as part of assistance data based upon the generated look-up table.

In accordance with certain example embodiments, a computer program product may perform a method. The method may include generating a look-up table configured to determine a transparent processing delay. The method may further include transmitting, during a user equipment-based positioning session, signal assistance data to a user equipment as part of assistance data based upon the generated look-up table.

In accordance with various example embodiments, an apparatus may include circuitry configured to generate a look-up table configured to determine a transparent processing delay. The circuitry may further be configured to transmit, during a user equipment-based positioning session, signal assistance data to a user equipment as part of assistance data based upon the generated look-up table.

In accordance with some example embodiments, a method may include receiving, by a user equipment, signal assistance data from a location management entity as part of assistance data. The method may further include receiving, by the user equipment, one or more of a positioning reference signal or other reference signal for timing estimation as part of a positioning procedure. The method may further include, based upon the signal assistance data and said one or more of the positioning reference signal or other reference signal, correcting, by the user equipment, a timing estimation according to a transparent processing delay. The method may further include calculating, by the user equipment, a position estimate based on the transparent processing delay according to a look-up table.

In accordance with certain example embodiments, an apparatus may include means for receiving signal assistance data from a location management entity as part of assistance data. The apparatus may further include means for receiving one or more of a positioning reference signal or other reference signal for timing estimation as part of a positioning procedure. The apparatus may further include means for, based upon the signal assistance data and said one or more of the positioning reference signal or other reference signal, correcting a timing estimation according to a transparent processing delay. The apparatus may further include means for calculating a position estimate based on the transparent processing delay according to a look-up table.

In accordance with various example embodiments, an apparatus may include at least one processor and at least one memory including computer program code. The at least one memory and the computer program code may be configured to, with the at least one processor, cause the apparatus to at least receive signal assistance data from a location management entity as part of assistance data. The at least one memory and the computer program code may be further configured to, with the at least one processor, cause the apparatus to at least receive one or more of a positioning reference signal or other reference signal for timing estimation as part of a positioning procedure. The at least one memory and the computer program code may be further configured to, with the at least one processor, cause the apparatus to at least, based upon the signal assistance data and said one or more of the positioning reference signal or other reference signal, correct a timing estimation according to a transparent processing delay. The at least one memory and the computer program code may be further configured to, with the at least one processor, cause the apparatus to at least calculate a position estimate based on the transparent processing delay according to a look-up table.

In accordance with some example embodiments, a non-transitory computer readable medium may be encoded with instructions that may, when executed in hardware, perform a method. The method may include receiving signal assistance data from a location management entity as part of assistance data. The method may further include receiving one or more of a positioning reference signal or other reference signal for timing estimation as part of a positioning procedure. The method may further include, based upon the signal assistance data and said one or more of the positioning reference signal or other reference signal, correcting a timing estimation according to a transparent processing delay. The method may further include calculating a position estimate based on the transparent processing delay according to a look-up table.

In accordance with certain example embodiments, a computer program product may perform a method. The method may include receiving signal assistance data from a location management entity as part of assistance data. The method may further include receiving one or more of a positioning reference signal or other reference signal for timing estimation as part of a positioning procedure. The method may further include, based upon the signal assistance data and said one or more of the positioning reference signal or other reference signal, correcting a timing estimation according to a transparent processing delay. The method may further include calculating a position estimate based on the transparent processing delay according to a look-up table.

In accordance with various example embodiments, an apparatus may include circuitry configured to receive signal assistance data from a location management entity as part of assistance data. The circuitry may further be configured to receive one or more of a positioning reference signal or other reference signal for timing estimation as part of a positioning procedure. The circuitry may further be configured to, based upon the signal assistance data and said one or more of the positioning reference signal or other reference signal, correct a timing estimation according to a transparent processing delay. The circuitry may further be configured to calculate a position estimate based on the transparent processing delay according to a look-up table.

### BRIEF DESCRIPTION OF THE DRAWINGS

For proper understanding of example embodiments, reference should be made to the accompanying drawings, wherein:

FIG. 1 illustrates an example of an NTN/HAPS network.

FIG. 2 illustrates an example of a processing delay that may be inherent in transparent NTN/HAPS networks.

FIG. 3 illustrates an example of a signaling diagram according to certain example embodiments.

FIG. 4 illustrates an example of online re-calibration using a terrestrial network (TN) and gateway, according to certain example embodiments.

FIG. 5 illustrates an example of a flow diagram of a method according to various example embodiments.

FIG. 6 illustrates an example of a flow diagram of another method according to various example embodiments.

FIG. 7 illustrates an example of a flow diagram of another method according to various example embodiments.

FIG. 8 illustrates an example of various network devices according to some example embodiments.

FIG. 9 illustrates an example of a 5G network and system architecture according to certain example embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for mitigating timing delays in positioning with HAPSs and/or NTNs is not intended to limit the scope of certain example embodiments, but is instead representative of selected example embodiments.

Native positioning support can include a variety of solutions, including downlink time difference of arrival (DL-TDOA), uplink time difference of arrival (UL-TDOA), downlink angle of departure (DL-AoD), uplink angle of arrival (UL-AoA), NR Enhanced Cell ID (E-CID), and multi-cell round trip time (Multi-RTT). Several of these techniques may include measuring the positioning reference signal (PRS) and sounding reference signal for positioning (SRS-P), and may be applied in scenarios such as industrial internet of things (IIoT) use cases. While some PRS and SRS-P may be reference signals defined by standards, certain embodiments discussed herein may apply to any reference signals, especially for positioning purposes. UE-based positioning may also be supported, where the UE calculates the location itself. UEs that support NTN may also have global navigation satellite system (GNSS) capabilities.

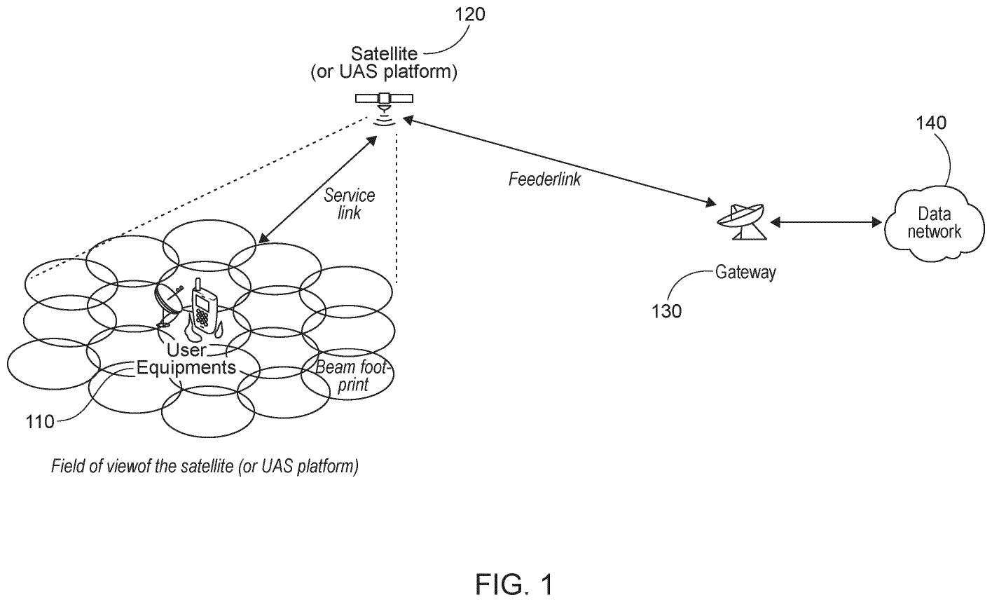

FIG. 1 illustrates an example of an NTN/HAPS network 100. As illustrated in the example of FIG. 1, communication services may be provided to the UE 110 through satellites and/or unmanned aircraft system (UAS) platforms (e.g., HAPS) 120. When using these platforms, user data may be routed through ground gateways 130 to data network 140, as well as the satellite and/or UAS platform 120. The wireless link between the satellite and gateway may be referred to as a “feeder link,” while the wireless link between the satellite 120 and UE 110 may be referred to as a “service link.”

5G NR radio interfaces may be implemented according to two architectures, depending on where the transmission and reception functions of the gNB are located. First, if the gNB digitally processes NR signals in the satellite, and the satellite uses NR transmission and reception points (TRPs), the satellite may be referred to as a “regenerative” satellite. Alternatively, if the gNB is co-located with the gateway, and the satellite only performs frequency conversion and amplification of the NR signal, the satellite may be referred to as a “transparent” (a.k.a., bent-pipe) satellite. Future networks may also begin to deploy positioning solutions in NTN/HAPS networks, where the UEs are required to be GNSS-capable.

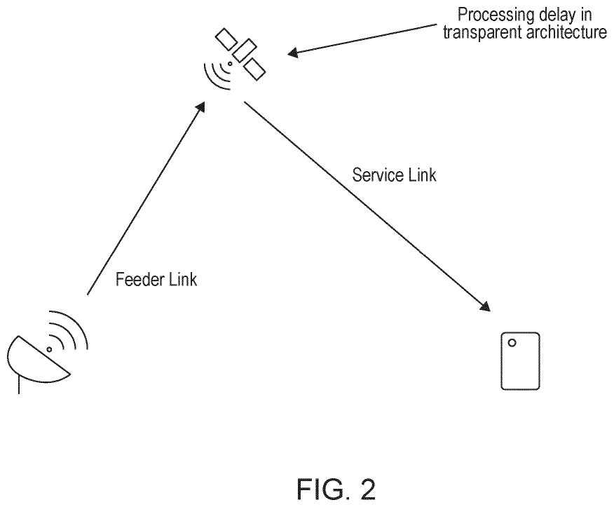

Baseline HAPS/NTN networks may include a transparent architecture where the HAPS/satellite serves as a repeater, and the gNB on the ground or near a gateway sends and receives signals to/from the UE through the HAPS/NTN. As an example, a NTN node may include the HAPS and/or satellite. The NTN (e.g., satellite) can perform some initial processing on received signals. For example, the feeder link and service link may have different carrier frequencies, and may require changes, such as to bandwidth, between the links. Thus, when a transparent NTN node is receiving/transmitting on the feeder link, there may be a delay introduced to the signal, which may be affected by frequency, bandwidth, temperature, etc. This delay may be referred to as a transparent processing delay. FIG. 2 illustrates an example of how this transparent processing delay may be introduced during NTN operations. In general, this transparent processing delay may be small in terms of data communications (e.g., less than 1 μs is not critical for communication when the NTN already has large propagation delays). However, this delay may need to be corrected during a positioning process, or else errors may occur. For example, if the UE is using the location of the NTN node, as well as estimated distance between the NTN node and UE, to assist in positioning, any transparent processing delay may result in errors (e.g., 1 μs=300 m ranging error). Some positioning cases may even require less than 10 m accuracy.

Certain example embodiments described herein may have various benefits and/or advantages to overcome the disadvantages described above. For example, certain example embodiments may mitigate the impact and errors caused by transparent processing delays on positioning or timing estimation performance. Specifically, various example embodiments may enable UEs to operate in NTN/HAPS networks without GNSS capabilities. As a result, positioning accuracy, as well as timing estimation at the UE (e.g., TA estimation or synchronization), may be improved. Thus, certain example embodiments discussed below are at least directed to improvements in computer-related technology.

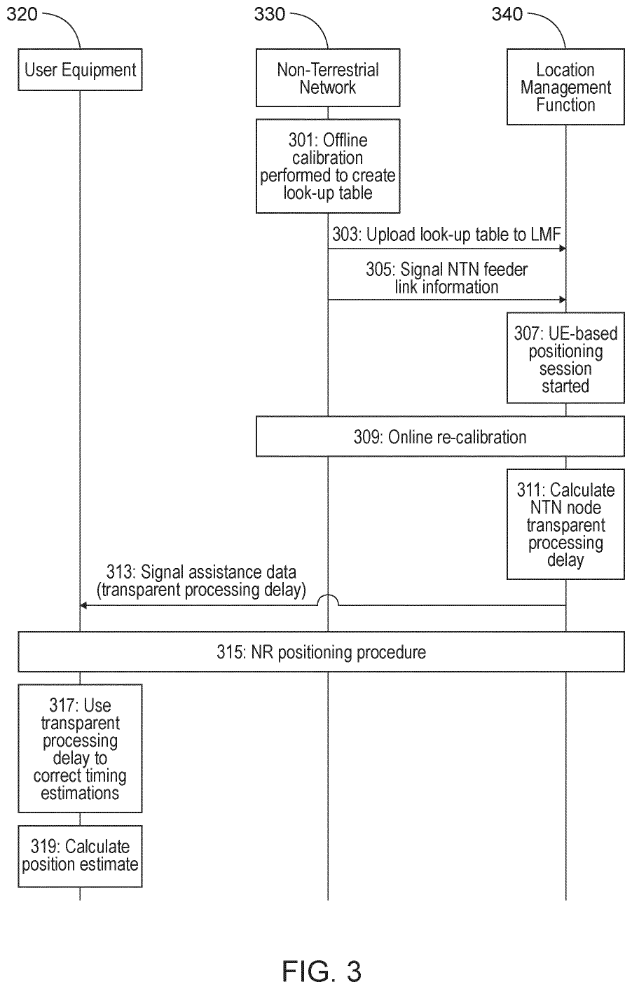

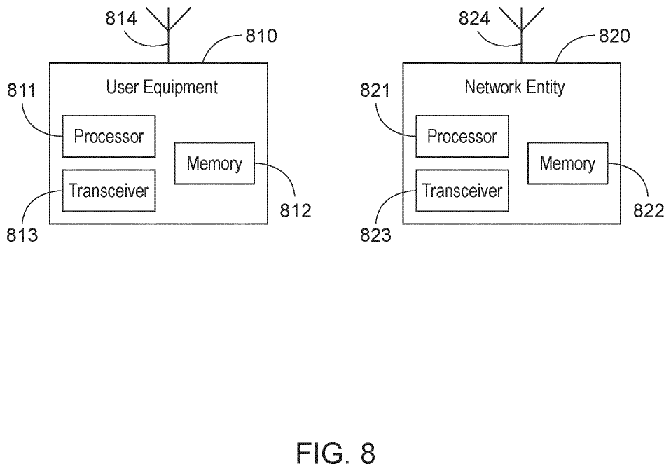

FIG. 3 illustrates an example of a signaling diagram depicting how to estimate offline, or recalibrate online, NTN transparent processing delays. In the example of FIG. 3, UE 320 may be similar to UE 810 discussed below, while NTN 330 and location management function (LMF) 340 may be similar to NE 820, as illustrated in FIG. 8, according to certain example embodiments.

In the example of FIG. 3, at 301, NTN 330 may characterize a transparent processing delay before NTN operation to perform offline calibration by creating a look-up table. The look-up table may be used to characterize a mean value of transparent processing delays, and may include at least one value associated with at least one of frequency, bandwidth, or temperature. The frequency and bandwidth of both the feeder link and the service link may be taken into account. The look-up table may be part of information sent on a control link from NTN 330 to a ground station and/or may be available at LMF 340 by O&M directly. In some example embodiments, LMF 340 may access the look-up table using a proprietary procedure. Based on required accuracy, the delay may also be re-calibrated online using one or more of several re-calibration techniques, described in more detail below. The look-up table may also be available and used by a gNB.

As illustrated in the example of FIG. 3, at 303, NTN 330 may transmit the look-up table to LMF 340. The NTN 330 may also determine the need to position UE 320 and/or receive a request from UE 320 to perform positioning or other relevant timing estimations. At 305, NTN 330 may also transmit NTN feeder link information to LMF 340. At 307, LMF 340 may start a UE-based positioning session. In some embodiments, LMF 340 may also determine that UE 320 is configured to perform positioning using NTN 330.

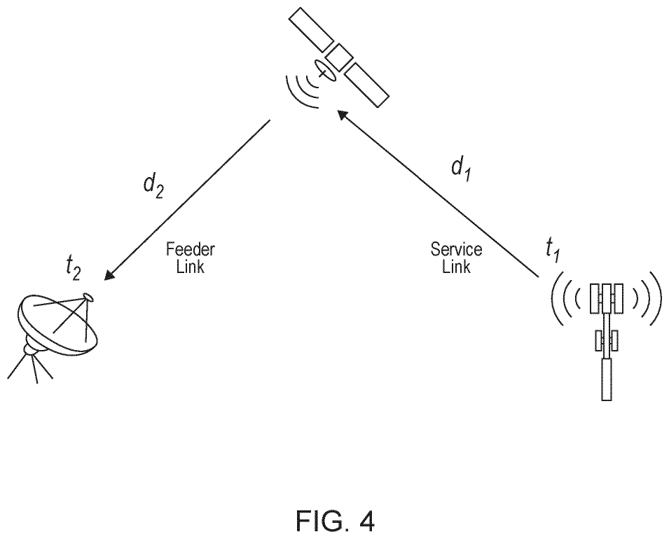

At 309, NTN 330 and/or LMF 340 may perform online re-calibration. For instance, in an embodiment, the known locations of NTN nodes, gateways, and reference UE/TN gNBs may be used to calibrate for an unknown processing delay onboard the NTN node. For example, as illustrated in FIG. 4, the TN gNB may transmit a time-stamped message at time t₁, which may be repeated by the satellite and received by the gateway at time time t₂. With the gNB-to-satellite distance d₁, and the satellite-to-gateway distance d₂ at the time the message was forwarded by the satellite, processing delay T may be calculated as T=(t₂−t₁)−(d₁+d₂)/c, where c is the speed of light.

In some example embodiments, two gateways may be used, with one gateway configured to receive on the service link frequency, and one gateway configured to transmit a reference signal at a known time to the other gateway (e.g., via NTN node). Certain example embodiments may include one gateway and one terrestrial network gNB, where the gNB is configured to transmit a reference signal on the service link and the gateway is configured to receive the reference signal on the feeder link via NTN node, as shown in FIG. 4. Similarly, certain example embodiments may include one gateway and one reference UE with a known fixed location, where the UE is configured to transmit a reference signal via the service link and the gateway is configured to receive the reference signal on the feeder link.

In some example embodiments, UE 320 may use its GNSS receiver, where it compares the position obtained at 309 to the position obtained from the LTE positioning protocol (LPP) to derive calibration information. According to certain example embodiments, this operation may be performed by UE 320 or LMF 340 (based on feedback from UE 320). Furthermore, some example embodiments may use higher-end UEs to calculate the processing delay, which may be used by other UEs that lack GNSS capabilities.

At 311, LMF 320 may use the look-up table to calculate a transparent processing delay. For example, the calculation may take into account the frequency of the feeder link, the service link, the bandwidths/frequencies of the positioning reference signals, and/or additional parameters like temperature of the NTN node. LMF 340 may obtain and/or utilize new messages from the gNB/NTN 330 to know the feeder link frequency, operating conditions of the NTN, etc. These new messages may include proprietary signalling or may be standardized via New Radio Positioning Protocol a (NRPPa).

At 313, LMF 340 may transmit signal assistance data (i.e., transparent processing delay) to UE 320 as part of new assistance data. For positioning purposes, the signal assistance data may be signalled as part of the LTE positioning protocol (LPP) from LMF 340 to UE 320. For non-positioning purposes (e.g., PD estimation), the signal assistance data may be signalled using radio resource control (RRC) and/or medium access control (MAC)-control element (CE). At 315, the NTN 330 may transmit PRS and/or other reference signals to UE 320 for timing estimation as part of the positioning procedure.

At 317, UE 320 may use transparent processing delays to correct timing estimations and, at 319, may calculate position estimates. In some example embodiments, UE 320 may remove the transparent processing delay from the timing estimate, thereby improving estimation performance.

Some example embodiments may also include timing advance (TA) estimation, time synchronization (e.g., PD compensation), and/or any other timing-based measurement performed by UE 320 which requires high accuracy. In an example embodiment, the provided processing delay values provided to UE 320 may be associated with specific reference signals and/or gNBs.

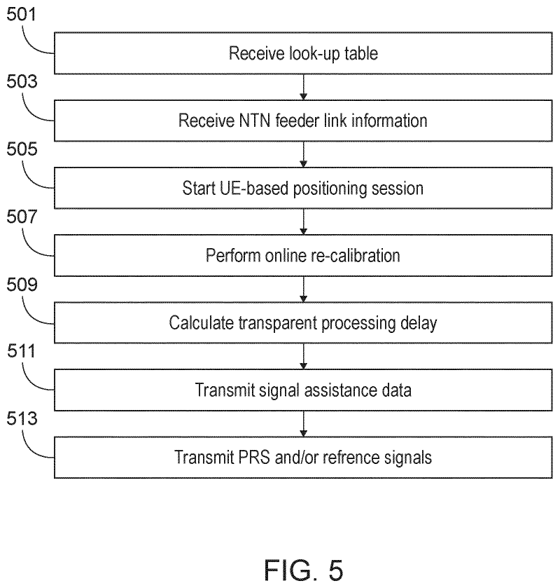

FIG. 5 illustrates an example of a flow diagram of a method, according to one example embodiment. In some example embodiments, the method of FIG. 5 may be performed by a network node, such as a location server, LMF or NE 820 illustrated in FIG. 8 discussed below.

In the example of FIG. 5, the method may include, at 501, receiving a look-up table from a NTN, which may be similar to NE 820 in FIG. 8. The look-up table may be used to characterize a mean value of transparent processing delays, and may include at least one value associated with at least one of frequency, bandwidth, or temperature. At 503, the method may include receiving NTN feeder link information from the NTN. At 505, the method may include starting a UE-based positioning session and/or determining that a UE is configured to perform positioning using the NTN.

At 507, the method may include performing online re-calibration. In one example embodiment, the performing 507 of the online re-calibration may include using the known locations of NTN nodes, gateways, and reference UE/TN gNBs to calibrate for an unknown processing delay onboard the NTN node. For example, as illustrated in FIG. 4, the TN gNB may transmit a time-stamped message at time t₁, which may be repeated by the satellite and received by the gateway at time time t₂. With the gNB-to-satellite distance d₁, and the satellite-to-gateway distance d₂ at the time the message was forwarded by the satellite, processing delay T may be calculated as T=(t₂−t₁)−(d₁+d₂)/c, where c is the speed of light.

In some example embodiments, two gateways may be used, with one gateway configured to receive on the service link frequency, and one gateway configured to transmit a reference signal at a known time to the other gateway (e.g., via NTN node). Certain example embodiments may include one gateway and one terrestrial network gNB, where the gNB is configured to transmit a reference signal on the service link and the gateway is configured to receive the reference signal on the feeder link via NTN node, as shown in FIG. 4. Similarly, certain example embodiments may include one gateway and one reference UE with a known fixed location, where the UE is configured to transmit a reference signal via the service link and the gateway is configured to receive the reference signal on the feeder link.

In some example embodiments, based upon feedback from the UE, the LMF may compare the position of the UE obtained by a GNSS received to the position of the UE obtained from the LPP to derive calibration information.

At 509, the method may include calculating the transparent processing delay using the look up table. For example, the calculating at 509 may take into account the frequency of the feeder link, the service link, the bandwidths of the positioning reference signals, and/or additional parameters like temperature of the NTN node. In some example, embodiments, new message(s) received from the gNB/NTN may be used to know the feeder link frequency, operating conditions of the NTN, etc. These message(s) may include proprietary signalling or may be standardized via NRPPa.

At 511, the method may include transmitting signal assistance data (i.e., transparent processing delay) to the UE as part of new assistance data. In one example embodiment, for positioning purposes, the signal assistance data may be signalled as part of the LPP from the LMF to the UE. In a further example embodiment, for non-positioning purposes (e.g., PD estimation), the signal assistance data may be signalled using RRC and/or MAC-CE. At 513, the method may include transmitting PRS and/or other reference signals to the UE for timing estimation as part of the positioning procedure.

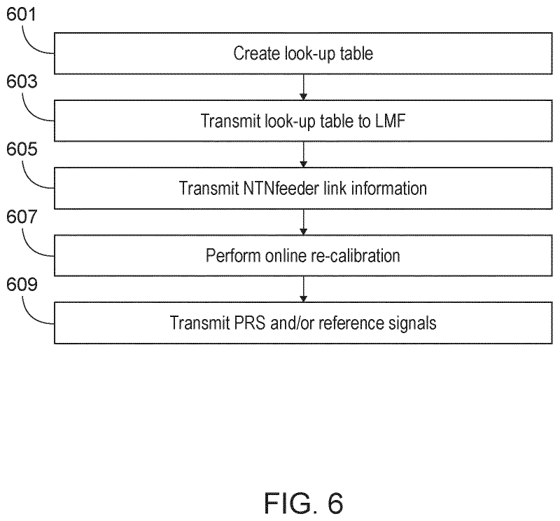

FIG. 6 illustrates an example of a flow diagram of a method, according to an example embodiment. The method depicted in the example of FIG. 6 may be performed by a network node or NTN, such as NE 820 illustrated in FIG. 8, according to various example embodiments.

As illustrated in the example of FIG. 6, at 601, the method may include characterizing a transparent processing delay before NTN to perform offline calibration by creating a look-up table, which may be used to characterize a mean value of transparent processing delays. The look-up table may be part of information sent on a control link from the NTN to a ground station and/or may be available at a LMF by O&M directly. In some example embodiments, the LMF may access the look-up table using a proprietary procedure. Based on required accuracy, the delay may also be re-calibrated online using of several re-calibration techniques, as described elsewhere herein. In certain example embodiments, the look-up table may also be available to and utilized by a gNB.

At 603, the method may include transmitting the look-up table to the LMF. In some example embodiments, the method may also include determining the need to position a UE (which may be similar to UE 810 in FIG. 8) and/or receiving a request from the UE to perform positioning or other relevant timing estimations.

At 605, the method may include transmitting NTN feeder link information to the LMF. At 607, the LMF may perform online re-configuration. At 609, the method may include transmitting PRS and/or other reference signals to the UE for timing estimation as part of the positioning procedure.

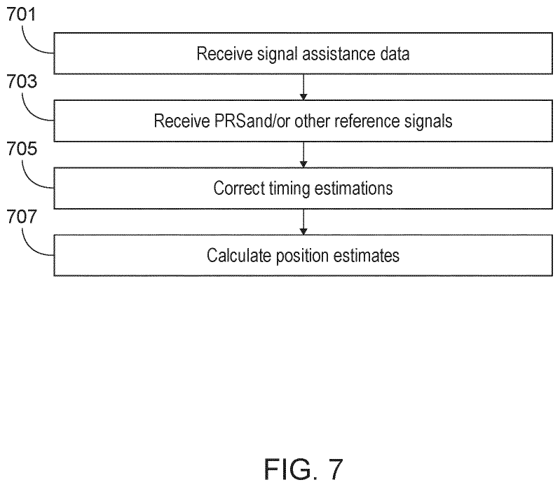

FIG. 7 illustrates an example of a flow diagram of a method, according to one example embodiment. In some example embodiments, the method illustrated in FIG. 7 may be performed by a UE, such as UE 810 illustrated in FIG. 8.

As illustrated in the example of FIG. 7, at 701, the method may include receiving signal assistance data (i.e., transparent processing delay) from a LMF (which may be similar to NE 820 in FIG. 8) as part of new assistance data. In an example embodiment, for positioning purposes, the signal assistance data may be signalled as part of the LPP from the LMF to the UE. In further example embodiments, for non-positioning purposes (e.g., PD estimation), the signal assistance data may be signalled using RRC and/or MAC-CE. At 703, the method may include receiving PRS and/or other reference signals for timing estimation as part of the positioning procedure.

At 705, the method may include correcting timing estimations using transparent processing delays and, at 707, calculating position estimates. In some example embodiments, the method may include removing the transparent processing delay from the timing estimate, thereby improving estimation performance.

Some example embodiments may also include TA estimation, time synchronization (e.g., PD compensation), and/or any other timing-based measurement performed by the UE which requires high accuracy. The provided processing delay values provided to the UE may be associated with specific reference signals and/or gNBs.

FIG. 8 illustrates an example of a system according to certain example embodiments. In one example embodiment, a system may include multiple devices, such as, for example, UE 810 and/or NE 820.

UE 810 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

NE 820 may be one or more of a base station, such as an eNB or gNB, a serving gateway, a server, satellite, and/or any other access node or combination thereof. Furthermore, UE 810 and/or NE 820 may be one or more of a citizens broadband radio service device (CBSD). Additionally or alternatively, NE 820 may be a LMF that is implemented in a RAN and/or may be a local location management component (LMC).

In some example embodiments, NE 820 may comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 810 and/or NE 820 may include at least one processor, respectively indicated as 811 and 821. Processors 811 and 821 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 812 and 822. The memory may be fixed or removable. The memory may include computer program instructions or computer code contained therein. Memories 812 and 822 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 811 and 821, memories 812 and 822, and any subset thereof, may be configured to provide means corresponding to the various blocks of FIGS. 3-7. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 8, transceivers 813 and 823 may be provided, and one or more devices may also include at least one antenna, respectively illustrated as 814 and 824. The device may have many antennas, such as an array of antennas configured for multiple input multiple output (MIMO) communications, or multiple antennas for multiple RATs. Other configurations of these devices, for example, may be provided. Transceivers 813 and 823 may be a transmitter, a receiver, both a transmitter and a receiver, or a unit or device that may be configured both for transmission and reception.

The memory and the computer program instructions may be configured, with the processor for the particular device, to cause a hardware apparatus, such as UE 810, to perform any of the processes described above (i.e., FIGS. 3-7). Therefore, in certain example embodiments, a non-transitory computer-readable medium may be encoded with computer instructions that, when executed in hardware, perform a process such as one of the processes described herein. Alternatively, certain example embodiments may be performed entirely in hardware.

In certain example embodiments, an apparatus may include circuitry configured to perform any of the processes or functions illustrated in FIGS. 3-7. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

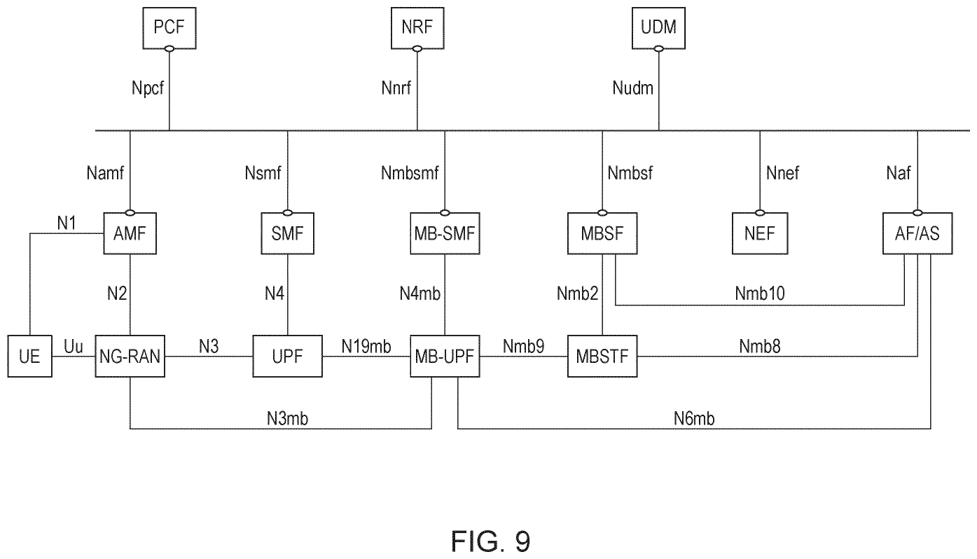

FIG. 9 illustrates an example of a 5G network and system architecture according to certain example embodiments. Shown are multiple network functions that may be implemented as software operating as part of a network device or dedicated hardware, as a network device itself or dedicated hardware, or as a virtual function operating as a network device or dedicated hardware. The UE and NE illustrated in FIG. 9 may be similar to UE 810 and NE 820, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some example embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP Third Generation Partnership Project
5G Fifth Generation
5GC Fifth Generation Core
5GS Fifth Generation System
AMF Access and Mobility Management Function
ASIC Application Specific Integrated Circuit
BS Base Station
BW Bandwidth
CBSD Citizens Broadband Radio Service Device
CN Core Network
CPU Central Processing Unit
eMBB Enhanced Mobile Broadband
eMTC Enhanced Machine Type Communication
eNB Evolved Node B
eOLLA Enhanced Outer Loop Link Adaptation
EPS Evolved Packet System
gNB Next Generation Node B
GPS Global Positioning System
HAPS High Altitude Platform System
HDD Hard Disk Drive
IEEE Institute of Electrical and Electronics Engineers
IIoT Industrial Internet of Things
IoT Internet of Things
LMF Location Management Function
LTE Long-Term Evolution
LTE-A Long-Term Evolution Advanced
LPP Long-Term Evolution Positioning Protocol
MAC Medium Access Control
MEMS Micro Electrical Mechanical System
MME Mobility Management Entity
mMTC Massive Machine Type Communication
MPDCCH Machine Type Communication Physical Downlink Control Channel
MTC Machine Type Communication
NAS Non-Access Stratum
NB-IoT Narrowband Internet of Things
NE Network Entity
NG Next Generation
NG-eNB Next Generation Evolved Node B
NG-RAN Next Generation Radio Access Network
NR New Radio
NR-U New Radio Unlicensed
NRPPa New Radio Positioning Protocol a
NTN Non-Terrestrial Network
OFDM Orthogonal Frequency Division Multiplexing
OLLA Outer Loop Link Adaptation
O&M Operations & Maintenance
PDA Personal Digital Assistance
PD Propagation Delay
PRB Physical Resource Block
PRS Positioning Reference Signal
RAM Random Access Memory
RAN Radio Access Network
RAT Radio Access Technology
RE Resource Element
RRC Radio Resource Control
RS Reference Signal
TN Terrestrial Network
TOA Time of Arrival
Tx Transmission
UCI Uplink Control Information
UE User Equipment
UMTS Universal Mobile Telecommunications System
URLLC Ultra-Reliable and Low-Latency Communication
UTRAN Universal Mobile Telecommunications System Terrestrial Radio Access Network
WLAN Wireless Local Area Network

1-63. (canceled)

64. An apparatus, comprising:
at least one processor; and
at least one memory including computer program code,
wherein the at least one memory and the computer program code are configured to, with the at least one processor, cause the apparatus at least to:
determine that a user equipment is configured to perform positioning using a transparent non-terrestrial network node;
calculate a transparent processing delay using a look-up table; and
transmit signal assistance data comprising the transparent processing delay.

65. The apparatus of claim 64, wherein the calculating is based upon at least one of bandwidth or frequency or temperature.

66. The apparatus of claim 64, wherein the at least one memory and the computer program code are further configured to, with the at least one processor, cause the apparatus at least to:
receive the look-up table from a non-terrestrial network.

67. The apparatus of claim 64, wherein the signal assistance data is transmitted using long-term evolution positioning protocol.

68. The apparatus of claim 64, wherein the signal assistance data is transmitted using radio resource control.

69. The apparatus of claim 64, wherein the signal assistance data is transmitted using one or more medium access control elements.

70. The apparatus of claim 64, further comprising:
performing, by the location management entity, an online re-calibration procedure.

71. The apparatus of claim 70, wherein the online re-calibration comprises at least one of:
a first gateway configured to transmit a reference signal, and a second gateway configured to receive the reference signal via an service link frequency and via the non-terrestrial network;
a terrestrial network base station configured to transmit a reference signal on a service link, and a gateway configured to receive the reference signal on a feeder link via a non-terrestrial node;
a user equipment with a fixed known location configured to transmit a reference signal on a service link, and a gateway configured to receive the reference signal on a feeder link; or
a user equipment configured to use a global navigation satellite system to compare a position obtained according to cellular-based positioning.

72. The apparatus of claim 64, wherein the at least one memory and the computer program code are further configured to, with the at least one processor, cause the apparatus at least to:
receive non-terrestrial network feeder link information from the non-terrestrial network.

73. The apparatus of claim 72, wherein the feeder link information comprises at least one of frequency, bandwidth, or temperature.

74. The apparatus of claim 64, wherein the at least one memory and the computer program code are further configured to, with the at least one processor, cause the apparatus at least to:
start a user equipment-based positioning session.

75. The apparatus of claim 64, wherein the at least one memory and the computer program code are further configured to, with the at least one processor, cause the apparatus at least to:
transmit one or more of a positioning reference signal or other reference signal to the user equipment for timing estimation as part of a positioning procedure.

76. An apparatus, comprising:
at least one processor; and
at least one memory including computer program code,
wherein the at least one memory and the computer program code are configured to, with the at least one processor, cause the apparatus at least to:
receive signal assistance data from a location management entity as part of assistance data;
receive one or more of a positioning reference signal or other reference signal for timing estimation as part of a positioning procedure;
based upon the signal assistance data and said one or more of the positioning reference signal or other reference signal, correct a timing estimation according to a transparent processing delay; and
calculate a position estimate based on the transparent processing delay according to a look-up table.

77. The apparatus of claim 76, wherein the signal assistance data is receiving using long-term evolution positioning protocol.

78. The apparatus of claim 76, wherein the signal assistance data is received using radio resource control.

79. The apparatus of claim 76, wherein the signal assistance data is received using one or more medium access control elements.

80. A method, comprising:
receiving, by a user equipment, signal assistance data from a location management entity as part of assistance data;
receiving, by the user equipment, one or more of a positioning reference signal or other reference signal for timing estimation as part of a positioning procedure;
based upon the signal assistance data and said one or more of the positioning reference signal or other reference signal, correcting, by the user equipment, a timing estimation according to a transparent processing delay; and
calculating, by the user equipment, a position estimate based on the transparent processing delay according to a look-up table.

81. The method of claim 80, wherein the signal assistance data is receiving using long-term evolution positioning protocol.

82. The method of claim 80, wherein the signal assistance data is received using radio resource control.

83. The method of claim 80, wherein the signal assistance data is received using one or more medium access control elements.
